(19) United States
(12) Patent Application Publication
(10) Pub. No.: US 2011/0106584 A1
(43) Pub. Date: May 5, 2011

(54) SYSTEM AND METHOD FOR MEASURING CUSTOMER INTEREST TO FORECAST ENTITY CONSUMPTION

(75) Inventors: Sara BORTHWICK, San Francisco, CA (US); Elizabeth LIGHTFOOT, Louisville, KY (US)

(73) Assignee: CBS INTERACTIVE, INC., San Francisco, CA (US)

(21) Appl. No.: 12/720,266

(22) Filed: Mar. 9, 2010

Related U.S. Application Data
(60) Provisional application No. 61/256,918, filed on Oct. 30, 2009.

(51) Int. Cl. G06Q 10/00

(52) U.S. Cl. 705/7.31

(57) ABSTRACT

A system and method comprises monitoring online user activity of one or more customers with regard to a first consumer entity. The user activity represents the one or more customer's interest in the first consumer entity categorized in a first product category. The method comprises monitoring the online user activity of the one more customers with regard to a second consumer entity categorized in a second product category different than the first category. The method comprises recording the monitored activity information to a data storage device and mapping it to a relational customer interest profile that represents a level of the one or more customer's interest at one or more corresponding phases of a consumption cycle with respect to the first and second consumer entities. The method comprises processing at least the mapped activity information to formulate a forecast of future consumption of at least the first consumer entity.

### CROSS-REFERENCE TO RELATED APPLICATIONS

The present application claims the benefit of priority based on U.S. Provisional Patent Application Ser. No. 61/256,918, filed on Oct. 30, 2009, in the name of inventors Sara Borthwick and Elizabeth Lightfoot, entitled “System And Method For Measuring Customer Interest To Forecast Entity Consumption”, commonly owned herewith.

### TECHNICAL FIELD

The present disclosure generally relates to a system and method for measuring customer interest to forecast entity consumption.

### BACKGROUND

Many media entities, such as software products, television programs and motion pictures, have lengthy, costly and unpredictable development cycles with rapidly evolving competition. In addition such media entities have many times been in direct correlation to the amount of marketing and promotion which was undertaken prior to, during and after the release of the media entity. It is desirable that the studio, producers, advertisers and other providers be able to accurately forecast the level of customer demand (through purchase, rental or other consumption) during the period leading up to and following an entity's launch and/or how that demand measures up against that of competitive entities.

Obtaining information on which to forecast sales has been attempted in various ways, primarily using historical sales data as a predictor of future sales. Certain proprietary forecasting systems use historical data and combine it with other inputs, such as type of entity, timing of release, marketing programs, and retail distribution plans. Despite their complexity, these forecasting systems are generally not accurate.

Other attempts to obtain information on which to forecast sales include focus groups, surveys, and other traditional research methods of sampling audience preferences. Because these techniques generally rely on small sample sizes and limited numbers of entities, and because they require a long time to execute and an additional long time to analyze, these techniques do not produce consistently accurate, useful, or timely results

With regard to media content, TV broadcasts have traditionally used statistical data to evaluate media consumption (i.e. Nielsen surveys) to gauge customer interest. For films and music, the appropriate amount of marketing and promotion before and during the release of the entity may be critical of the entity's success. For TV programs which are run on broadcast networks, revenue from advertising is based on the popularity of the programs and is thus significantly important to the networks. However, the amount of customer interest has been loosely predicted whereby the amount of needed marketing and promotion is many times a guessing game based on those loose predictions.

Accordingly, there is a need for a system and method in which future consumption of or interest in one or more entities, or a category thereof, may be quickly, easily and accurately forecasted.

### OVERVIEW

In an aspect, a method comprises monitoring online user activity of one or more customers with regard to a first consumer entity. The user activity represents the one or more customer's interest in the first consumer entity, whereby the consumer entity is categorized in a first product category. The method comprises monitoring the online user activity of the one more customers with regard to a second consumer entity categorized in a second product category different than the first category. The method comprises recording the gathered activity information to one or more memory or data storage devices associated with a computer. The method comprises mapping the gathered activity information to a relational customer interest profile that represents a level of the one or more customer's interest at one or more corresponding phases of a consumption cycle with respect to the first and second consumer entities, wherein the mapping is performed by a processor. The method comprises processing at least the mapped activity information to formulate a forecast of future consumption of at least the first consumer entity, wherein the processing is performed by the processor or another processor.

In an aspect, a system comprises means for monitoring online user activity of one or more customers with regard to a first consumer entity, wherein the user activity represents the one or more customer's interest in the first consumer entity being categorized in a first product category. The system comprises means for monitoring the online user activity of the one more customers with regard to a second consumer entity categorized in a second product category that is different than the first category. The system comprises means for recording the monitored activity information to one or more memory or data storage devices associated with a computer. The system comprises means for mapping the monitored activity information to a relational customer interest profile that represents a level of the one or more customer's interest at one or more corresponding phases of a consumption cycle with respect to the first and second consumer entities, wherein the mapping is performed by a processor. The system comprises means for processing at least the mapped activity information to formulate a forecast of future consumption of at least the first consumer entity, wherein the processing is performed by the processor or another processor.

In either or all of the above aspects, the activity information of the first consumer entity includes consumption of the first consumer entity and/or second consumer entity. In either or all of the above aspects, the first or second consumer entity is a television program, wherein the television program is viewable via a video player on an Internet web site. In either or all of the above aspects, the first or second consumer entity is an audio file, book, article, movie, album, song, video game and the like. In either or all of the above aspects, monitoring of the customer activity on a first Internet web site displays information the first consumer entity and a second Internet web site displays information of the second consumer entity. In either or all of the above aspects, monitoring customer activity information further comprises monitoring customer activity between more than one Internet web site. In either or all of the above aspects, monitoring customer activity further comprises monitoring a media file which is consumed by the customer via an Internet web site. In either or all of the above aspects, monitoring activity information further comprises monitoring a keyword search performed by a user on an Internet web site. In either or all of the above aspects, processing further comprises weighting scores of information contributing to the customer interest profile in corresponding phases of the consumption cycle; combining the weighted scores so as to form a power score; and determining the forecast of future consumption of the first consumer entity based on the power score. In either or all of the above aspects, the activity information further comprises at least one of click data representing customer activity between a plurality of Internet web sites; metadata representing entity attributes; customer data representing attributes of at least one customer's respective activities; and contextual data representing contexts of entities.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1 is a high-level flowchart illustrating basic an embodiment of a method of monitoring activity of customers with reference to an entity in accordance with an embodiment.

FIG. 2 illustrates an example entity interest profile in accordance with an embodiment.

FIG. 3 illustrates a data flow diagram corresponding to an embodiment.

FIG. 4 illustrates a flowchart detailing an embodiment of gathering activity information of customers.

FIG. 5 illustrates a flowchart detailing the mapping the activity information to the entity interest profile in phases of a consumption cycle in accordance with an embodiment.

FIG. 6 illustrates a flowchart detailing the processing the entity interest profile 210 to forecast future consumption of the entity in accordance with an embodiment.

FIG. 7 illustrates a diagram of the system capable of monitoring customer activities among one or more Internet sites in accordance with an embodiment.

FIG. 8 illustrates a schematic hardware block diagram of the system in accordance with an embodiment.

FIG. 9 illustrates an example of a display produced by the system in accordance with an embodiment.

### DESCRIPTION OF EXAMPLE EMBODIMENTS

Example embodiments are described herein in the context of a system of computers, servers, and software. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used throughout the drawings and the following description to refer to the same or like items.

In the interest of clarity, not all of the routine features of the implementations described herein are shown and described. It will, of course, be appreciated that in the development of any such actual implementation, numerous implementation-specific decisions be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. It is understood that the phrase “an embodiment” encompasses more than one embodiment and is thus not limited to only one embodiment. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

Various aspects, features and embodiments may be described in terms of a process that can be depicted as a flowchart, a data flow diagram, a structure diagram, or a block diagram. Although a flowchart may describe the operations as a sequential process, many of the operations can be performed in parallel, concurrently, or in a different order than that illustrated. Operations not needed or desired for a particular implementation may be omitted.

For brevity, the terms “computer” and “computer system” are employed. However, a single unit (box) is not all that these terms are intended to cover. The terms also encompass plural computers that may be arranged in a network. For brevity, the terms “customer” and “customers” are used herein, and these term do not require that the individual or individuals have actually made a purchase or actually consumed the material. For example, the individuals may have consumed media content in the form of streaming or downloaded video and/or audio which was available for free, whereby the media content is supported by one or more advertisements that the customer watch prior to or during the viewing of the media content. As used in this disclosure, “customer” is understood to encompass prospective customers and potential customers who have not actually consumed the material, but who may be visiting an Internet web site through which the system monitors their activity to determine customer interest.

In this disclosure, embodiments are often described with reference to consumer “entity or entities,” such as video games, broadcasted programming and media content (e.g. TV broadcasts, films, music, videos) and other media that are marketed, downloaded, streamed, sold or otherwise consumed via an Internet or non-Internet site (e.g. brick and mortar distributor). “Entity” or “entities” (hereinafter generally referred to as “entity”) may also refer to digital and non-digital media including, but not limited, articles, books, advertisements, news magazines, periodicals, journals, blogs, presentations, documents and the like. In addition to entities, reference is often made herein to “product,” “product-specific” activities, and “product-specific” information. However, these terms are understood to be encompassed as entities which may have physical (e.g. movie sold in the form of a packaged DVD) or non-physical (e.g. movies sold and viewed by being downloaded or streamed over the Internet). A product category may refer to a database containing entities of the same general type of product. For example, a movies product category will generally contain only movies which may be of a non-physical nature (e.g. consumed on line) or of a physical nature (e.g. purchasable DVD), whereby the movie product category is a different category than a music product category, a video game product category or a book product category.

Even more generally, the monitoring and forecasting functions employed by the system may be applied to measure potential consumer interest, described herein as a customer interest profile, in one or more entities to predict future sales in those entities or to project future levels of interest in those entities. The system can also monitor customer activity an entity in one product category on an ongoing and real time basis. This is described in U.S. Ser. No. 10/429,929.

The system is desirably used to monitor customer activity relating to entities in different categories (e.g. one or more movies and one or more books, music tracks or albums, and the like on the same of different websites) on an ongoing and real time basis and thereby generate relational information of consumer interest between those different product entities to forecast future consumption of one or more of those different product entities. Thus, as used in the specification, the “consumption” of an “entity” or “product” may be broadly interpreted as any interest in a given entity, plurality of entities, or category of entities within one product category or between two or more product categories. This is an improvement in business intelligence and forecasting analysis over the system described in U.S. Ser. No. 10/429,929 since the present system is able to take into account customer behavior among different, apparently non-related product areas to establish a broader interest base of the customers. Thus, the system is a substantial improvement over monitoring customer interest with regard to one product.

As such, a variety of different consumer entities can be monitored by the system for forecasting interest among the same product category or between different product categories of entities, including but not limited to: one or more physical entities (for example, a particular book, DVD, or CD); one or more electronic entities (for example, a particular downloaded computer game, television broadcasted program, digitally distributed music or movie file, music track or album and the like).

The system may monitor customer activity among plural distinct entities in a set in which the entities in the set have one or more common attributes. For example, the system may monitor customer activity in a set of the five most popular aircraft flight simulator programs; an artist's three most recently released albums (i.e. the artist being the commonality among the albums in the set); movies directed or produced by a particular individual or studio and generate a relational customer interest profile between the three different product categories. In another example, as discussed below, the system may monitor customer activity among different types of entities to determine a relational customer interest relationship between the two entities that do not have an obvious common attribute (i.e. customers viewing television program and then searching for a Blu-Ray™ disc of the program; customer viewing a movie program and then searching a music provider website for music contained in that movie program).

Thus, the system monitors activity of one or more customers relating to interest in different entities across different product categories in forecasting customer interest of a potential relationship between those entities. Other entities include entire classes or categories of entities (for example, games on CD as distinguished from downloaded games; books on international politics); abstract entities or topics (for example, “reality television” programs in general, network television or cable news coverage of wars.) In these cases, consumer interest or consumption of the entity would involve the customer's merely viewing information of a program on a website or actually viewing the program on a website or on their television, (rather than purchasing or renting a physical or electronic entity). Entities also encompass broader concepts (for example, computer games from one or more particular manufacturers or developers; movies about skateboarding; programs for the Xbox™, and so forth). For example, the system may provide a customer interest profile may be based on relational customer interest among one or more game developers who make skateboarding games and movies about skateboarding by one or more movie production companies.

The ability to monitor and forecast broad concepts is especially useful when concepts precede the release of the actual entities. Forecasting broad concepts allows a manufacturer, studio or developer to monitor customers' awareness and consideration for a concept, without being limited or committed to individual entities falling under that concept.

In the scenario that a particular entity has already been introduced in the marketplace, the manufacturer, studio or developer would be able to utilize the system to track customer activity deeper into the entity cycle, which would then augment knowledge about the entities as well as any broader concepts.

The system may also be used to forecast or predict customer interest for an entity which has not been introduced in the market or has not been broadcast yet to determine accurate revenue models. Forecasting broad concepts may allow a television studio or distributor to gauge or forecast how much customer interest has been monitored and thereby provide optimal advertising rates to advertisers. For instance, a television studio may utilize the system to monitor and forecast that the number of anticipated viewers for an upcoming television program will be extremely high, and thereby increase the price of the advertising slots during that program accordingly. The television studio may also utilize the findings by the system to support the increased prices in the advertising slots.

In the case of consumer entities which are physical manufactured entities, accurate forecasts produced by the present system of customer demand would permit manufacturers to reduce oversupply (excess inventory) or undersupply (inadequate inventory) of the entity being marketed. Accurate forecasts would also allow manufacturers to assess the sales potential of their entities, both in objective terms and in relation to their competitive set, allowing the manufacturers to forecast sales volume. Moreover, this information would allow manufacturers to monitor their success in building and maintaining demand, ultimately allowing them to run more profitable businesses.

For example, assuming that a new operating system is announced but not yet released. The disclosed system would monitor news on the development of the new operating system and/or one or more customers' activity among one or more website in which the customers' activities would indicate their interest (and potential purchase) of the new operating system. The system in effect monitors customers' awareness, consideration and overall interest for that operating system. If the system determines that there are is a substantial amount of customer activity with respect to the new operating system, the system is able to extrapolate data as to how much supply of that operating system (or in contrast, how much more marketing) is needed.

In an embodiment, if it is publicized that various specific applications programs that operate on the new operating system are available, they are monitored throughout an entire consumption cycle to gather information for these entities. Both the levels of activity (news) of the operating system in general, customer activity with respect to those particular application programs and the information specific to those programs, can be processed by the present system to create an overall score for the entity. The system can compare the score to an existing operating system which has already been released to the public to create a realistic forecast for consumption of the new operating system. Also, this information gathering process utilized by the system can provide information to manufacturer or developer to learn that a particular applications program is driving the majority of purchase demand for the operating system in general. The system can also monitor navigation behavior of the customers with respect to the operating system in the example to provide data which may be analyzed to determine why the operating system is of particular interest to the customers.

Thus, the monitoring and forecasting functions disclosed in this specification may be applied to any entity (physical, electronic, or abstract) regarding which relevant data can be gathered and mapped to the customers' entity interest profile and be processed to forecast consumption (purchase, rental, viewing, interest, and so forth) of the entity.

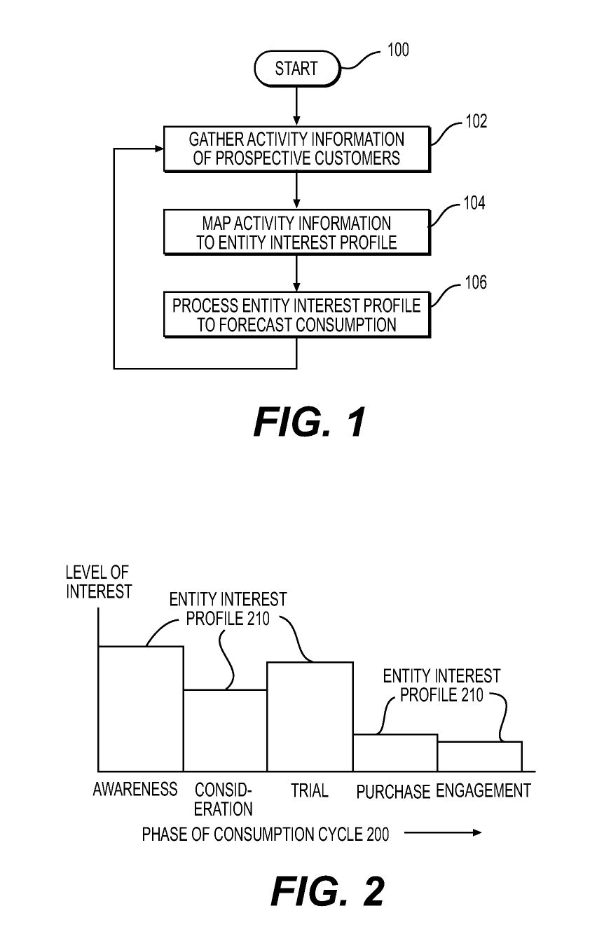

Reference is now made to the accompanying drawings and the following text for a description of particular embodiments. FIG. 1 is a high-level flowchart illustrating a method of monitoring activity of customers with reference to an entity in order to enable a forecast of future consumption of the entity. The method starts at block 100.

Block 102 represents a step of gathering activity information of customers relating to one or more entities. As a basis for one embodiment, it is recognized that extremely large numbers of customers, well into the hundreds of thousands, visit one or more Internet web sites each day to obtain entity-specific information. This entity-specific information may even include information for entities that have not yet been launched, broadcasted or introduced into the marketplace. For example, past and current customer interest in a particular television program which has a yet unreleased spin off or related program may provide valuable information of consumer interest in the spin off or related program.

According to this embodiment, the customers' entity-specific activity at the web site is monitored, such as by “counting clicks” and tracking the context and/or sequence in which the customers clicked various links. For example, a customer may navigate among several websites in which entities viewed by the customer may signal a potential relationship between those entities. The information may be categorized and recorded at intervals (such as daily) by an automated system in coordination with unique entity identifiers. As such, the monitoring occurs in near real time and makes that information timely, relevant and easy to access.

Besides web site activity, other entity-specific activity may be monitored by the system. For example, editorial coverage of the entity or category of entities may be monitored by the system. Monitored editorials may be at multiple outlets, both online and offline. This monitoring may include the recording of: editorial events; the date of the events; the type of events (review, cover story, preview, etc.); the review scores or ratings; and/or other entity-specific editorial coverage information; amount of advertising or other coverage which discusses the entity.

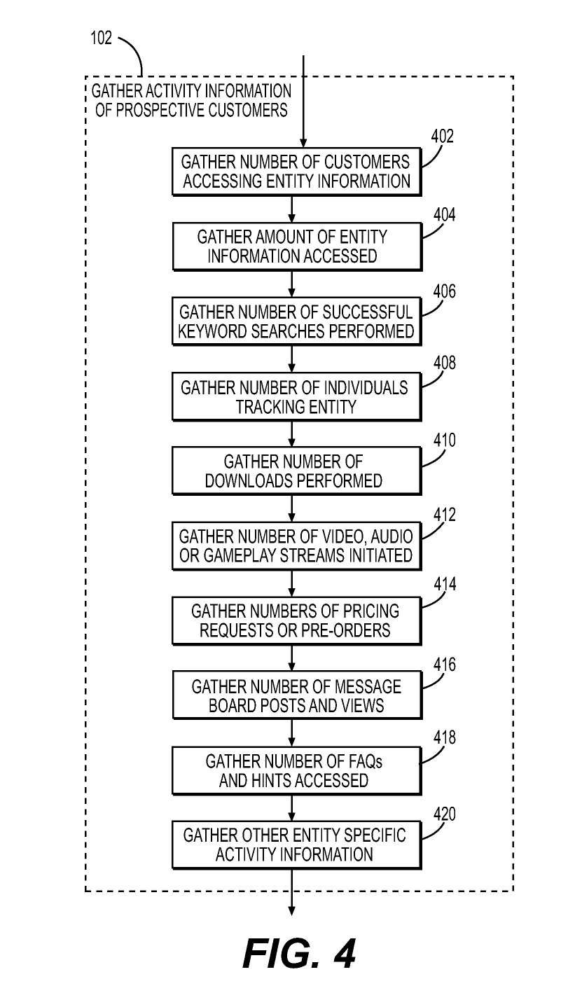

FIG. 4, showing an embodiment of data gathering step 102, is described in greater detail below. Referring again to FIG. 1, block 104 represents a step of mapping the activity information gathered in step 102 to an entity interest profile 210 (see FIG. 2, discussed below). An entity interest profile represents a predicted, projected or actual level of interest of one or more customers toward an entity at respective phases of a consumption cycle 200 (see FIG. 2).

A consumption cycle 200 may be, for example, a series of phases culminating in the purchase or rental of a physical or electronic entity, in the selection and/or viewing of a topic of interest, in the future interest in an abstract topic, and so forth. The consumption cycle 200 may encompass the consumers just viewing previews or other information regarding the entity. Additionally or alternatively, the consumption cycle 200 may include the streaming or downloading of all or a portion of a video file of the entity (e.g. entity is a television program or movie), streaming or downloading all or a portion of an audio file of the entity (e.g. entity is an album or song); viewing all or a portion of an article or book from an Internet site and the like.

In one example that is shown in FIG. 2, a consumption cycle includes the following phases: Phase 1: awareness of the entity (or entity group, or entity category, or other entity); Phase 2: consideration of the entity; Phase 3: trial of the entity; Phase 4: purchase of the entity; and Phase 5: engagement (a phase of the consumption cycle relating to repeat customers).

Engagement measures customers' post-consumption affinity for more of the same entity, for future versions of the same entity, for similar entities, and so forth. In the context of television broadcasts, other programs similar to the television program searched for and/or viewed by the user which may be of interest to the customer may preferably be identified in the engagement phase. In an embodiment, the system may monitor customers previewing or consuming other entities which have similar attributes (e.g. same actors, same producers, same musicians and the like) to the earlier consumed entity. For example, the system may monitor customers viewing a particular television program and then clicking on “OTHER VIEWERS ALSO WATCHED” OR “SIMILAR PROGRAMS WHICH MAY INTEREST YOU” to watch other programs similar to the previously viewed program. In another example, the system may monitor customers viewing a particular television program and then clicking on “OTHER PROGRAMS HAVING ACTOR X” OR “OTHER PROGRAMS DIRECTED BY DIRECTOR X.”

As illustrated in FIG. 2, each phase of the consumption cycle 200 (represented on the horizontal axis) has a respective measure (represented on the vertical axis) of the mindset or level of interest of customers. The measure of the level of interest constitutes the users' entity interest profile 210. In the illustrated representation of the consumption cycle, the phases are arranged as generally chronological steps, but from an analytical perspective a chronological ordering is not necessary.

Although each phase is illustrated as having only a single measured value, it is understood that many items of data may contribute to the this measured value. Accordingly, other examples of entity interest profiles may have more than one value per phase, indicating persistence of the data items even beyond the step in which they are mapped to a phase.

Moreover, it is recognized that a given customer need not have to pass through each phase: for example, a customer may consider the entity (phase 2) and proceed directly to purchasing it (phase 4) without trying it first (phase 3). The entity interest profile 210 is generated from the activity of large numbers of customers, and thus the effect of the idiosyncrasies of one individual on the final consumption forecast is minimized. Based on analytic processing techniques described below, it is the composite actions of those large numbers of customers that determines the forecast of consumption.

In one implementation of mapping step 104, the mapping is accomplished by merely storing data in destination storage locations that specifically correspond to a phase of the consumption cycle. In that embodiment, the data is not “tagged” as such. Accordingly, any process that reads the stored data knows the phase to which the data belongs, based simply on the data's storage location. Of course, alternative approaches to indicating the mapping, such as tagging the data by adding a “phase” field, can also be implemented.

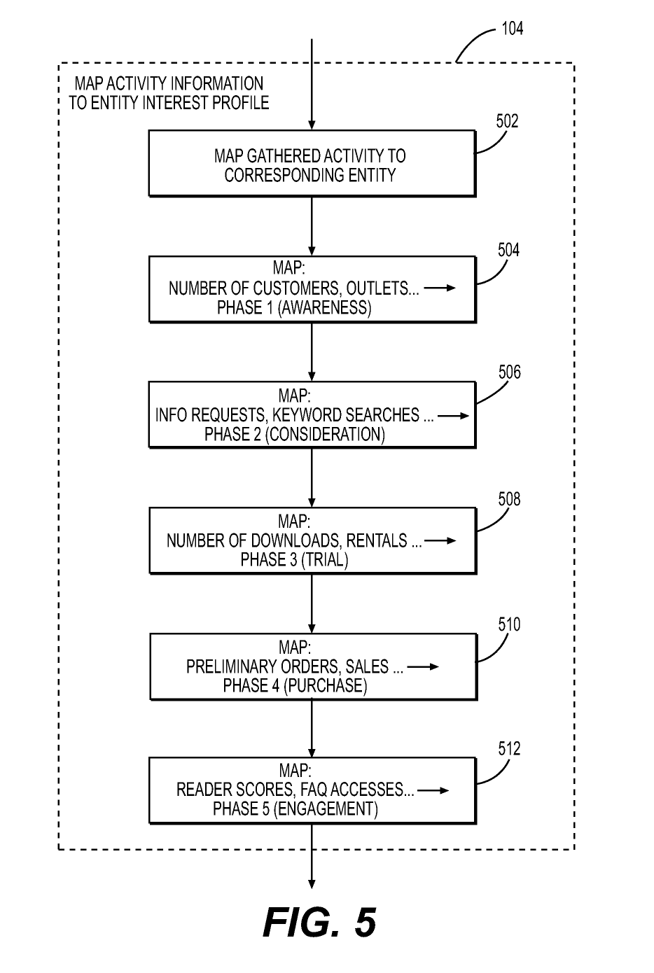

FIG. 5 illustrates some of the steps that may be included within mapping step 104 (FIG. 1). FIG. 5 is described in greater detail below. Referring again to FIG. 1, block 106 represents a step of processing the entity interest profile from step 104, to forecast consumption of the entity.

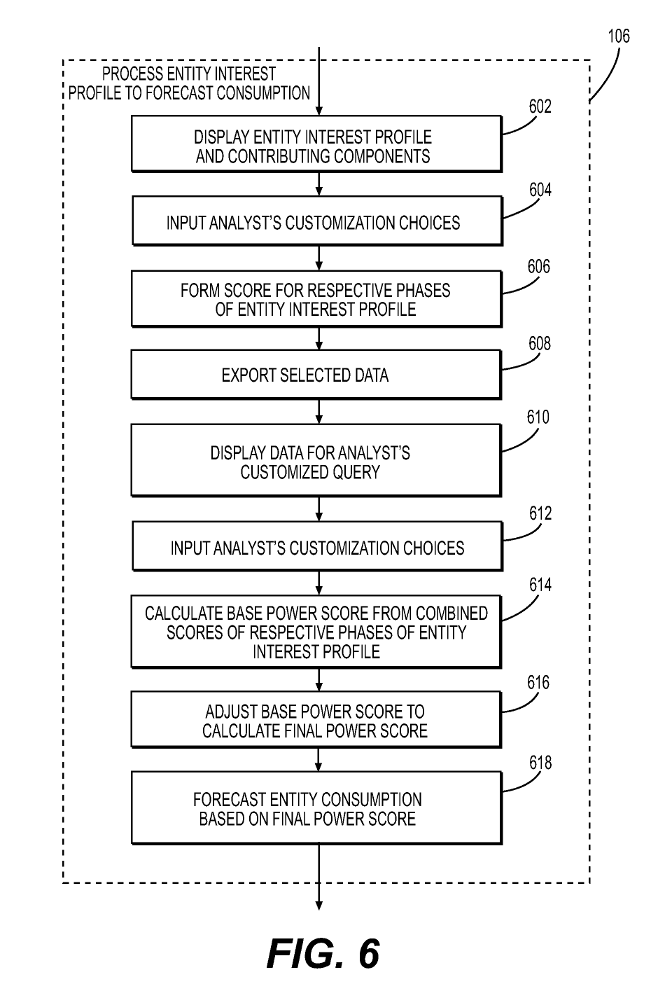

FIG. 6 illustrates some of the steps that may be included within an implementation of step 106. FIG. 6 is described in greater detail below. However, briefly, the processing step 106 may optionally include displaying to an analyst or other interested individual, the entity interest profile 210 (see example in FIG. 2) and its contributing components (see FIG. 5) and relevant data. The analyst may review the profile and its contributing components and relevant data, and, based on his review and analysis, the analyst may customize the way in which the processing is carried out.

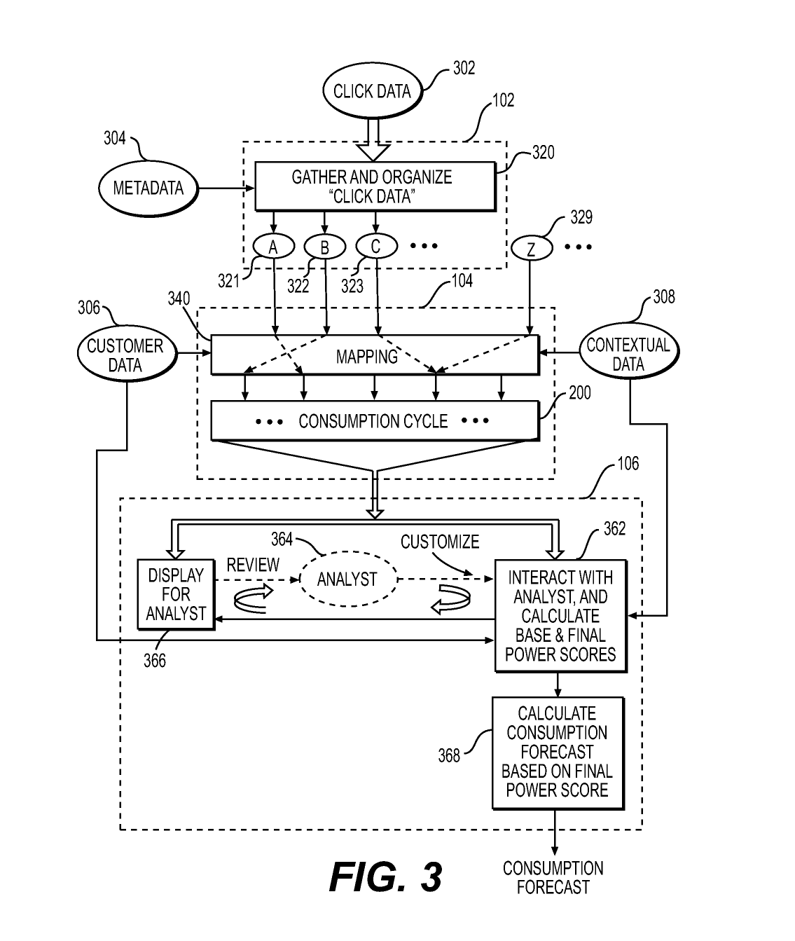

Regardless of whether or not an analyst customizes processing of a particular entity interest profile, processing step 106 includes combining scores of data mapped to the various phases of the consumption cycle, to arrive at a combined value or score, which may be referred to as a “power score.” The power score determines the forecast of consumption of the entity, entity category, or other entity being studied. In one embodiment, a base power score is formed, but is then refined to form a final power scored (see discussion of FIGS. 3 and 6) from which the forecast is determined.

FIG. 3 illustrates a data flow diagram corresponding to an embodiment of the method shown in FIG. 1. More specifically, FIG. 3 blocks 102, 104, 106 are processes that correspond to information gathering step 102, mapping step 104 and processing step 106 (FIG. 1).

The processes preferably input and output data as indicated in FIG. 3. Data types shown in FIG. 3 include: Click data 302; Metadata 304; Customer data 306; and Contextual data 308. It is contemplated that other forms of data may be used by the system and is not limited those described above.

Click data 302 most closely resembles “raw data” in the common understanding of the term, in that it generally does not enter the “control inputs” of any processes. In contrast, metadata 304, customer data 306 and contextual data 308, while preferably collected over time, differ from click data in that they generally are generally received at the “control inputs” of processes. Of course, it is understood that the distinction between “raw data” and “control input data” is artificial, and that particular types of data (for example, data representing editorials about a entity) can be used either as raw data or as control data or as both.

“Click data” 302 data preferably refers to data points derived or inferred from actions that are initiated by one or more customers in relation to a specific entity, usually via an interactive online application on an Internet web site. The system preferably monitors and stores the Click data across one or more web sites. Click data may be data of the type shown in and described with respect to FIG. 4, and is described in detail below.

“Metadata” 304 may be any data that relates to objective, standardized attributes of the entity or other subject, such as (in the example of a video game or computer game): Name; Developer; Publisher or manufacturer; Category; Release date; Platform; Features (number of players, online capability, etc.); System requirements; Franchise; and/or License. For television programs which are streamed or downloaded by the user, Metadata may contain information of the program, the studio, artist, type of program (e.g. comedy, drama), and/or producer as well as other relevant information. For audio based content which are streamed or downloaded by the user, Metadata may contain information of the program, including the studio, producer, artist, Beats per Minute, genre, year produced and/or other relevant information. Of course, the particular elements of the metadata depend on the characteristics of the entity or other entity under consideration; the listed metadata elements are illustrative, non-limiting examples.

“Customer data” 306 is preferably data that pertains to specific customers. Normally, the customers under consideration are individuals who visit web sites that are monitored for the click data 302 they generate. In one embodiment, customer data 306 includes: demographic data; session data; click history data; consumption cycle history data, data points that may be inferred from the demographic, session, click history, and consumption cycle history data (for example, brand preferences, purchase patterns, and so forth). Particular activity engaged by the user, such as posting a comment, providing a review, recommending or sharing the entity, and the like may be attributed to customer data. This activity may be monitored, gathered and stored by the system to develop the customer interest profile. In an example, the system may utilize this particular activity as a primary or secondary aid in developing a relational customer interest profile in the situation that the user expresses a like or dislike of an entity in another product category from the category in which the user is making the expression (e.g. “I liked this episode and want to buy the song in it by band XYZ”).

Customer data 306 may be gathered as follows. A unique customer identifier (customer ID) such as a conventional “cookie” is placed on browsers accessing the site. A customer ID record, created by registration, contains demographic data such as age, gender, and ZIP code. The cookie is mapped to a customer ID record, if it has previously been created. If the customer is not already registered, this mapping is not possible, and a new anonymous customer ID record is created.

For future sessions from each browser, click data is stored in the appropriate unique ID record, including but not limited to information such as entities accessed, clicks by type (for example, editorial, download, hint), sequence of clicks, and time of the monitored activity on a particular web site. If a particular customer is registered, additional data (for example, message board postings, entity ratings, tracked entity history, purchased entity history) may also be gathered and stored.

After customer data 306 has thus been gathered, the monitoring and forecasting arrangement of the system may use the customer data in a variety of ways. Some examples of how the customer data may be presented and forecasted is by views that show an individual's or group of individuals' history and preferences at any point in time and over time. To allow consumption cycle data and trends to be overlaid against demographics (for example, to visually show a correlation of how a given entity is tracking against customers of a certain gender, race and/or age group) to determine current and future demand among specific demographic sets. For example, such data may show how successful a particular computer game or television program will be in the Southeast vs. the West Coast, among older customers vs. younger customers, among male customers vs. female customers and the like. In the television program context, such information may be valuable to advertisers who are interested in running an advertisement during the airing of the program.

“Contextual data” 308 is preferably data related to a specific entity that provides a context for that entity in terms of various categories. Contextual data 308 may include: editorial data (for example, the number of editorial outlets that have covered the entity, and the time and type of coverage generated); review or scoring data (for example, data regarding the score or grade given to the entity by individual outlets, or an aggregate of data from many outlets); comments or community discussion of the particular entity on comment boards and blogs. Additionally or alternatively, contextual data may encompass advertising/marketing data (for example, relating to the quantity, timing, placement, and type of promotions run on various media and marketing vehicles); sales data (for example, historical data regarding the number of units sold of a specific entity); and/or public relations (PR) data (for example, data relating to the quantity, timing of PR-related programs and efforts). With this background understanding of how the system may utilize click data 302, metadata 304, customer data 306, and contextual data 308, the data flow diagram of FIG. 3 is now described.

Referring to FIG. 3, click data 302 is gathered and organized by element 320 within the information gathering process 102. The click data is preferably organized at least in part according to the metadata 304 of the respective entities being monitored by the one or more customers. Correlating the click data to corresponding entities ensures that subsequent analysis of the click data by processes 104, 106 is carried out on the proper entities. FIG. 3 elements 321, 322, 323 represent examples of click data that has been organized by entity and by click data type. For example, organized data element 321 may be the number of keyword searches performed by the one or more customers; organized data element 322 may be the number of unique customers accessing entity information; and organized data element 323 may be the number of sales made over the web site and the like. Other organized data elements may include, but is not limited to, the number of comments made by a user which mentions the entity; number of recommendations made by one or more customers on the entity and the like. In an example, organized data element 329 may be customer activity received from a partner web site or actual sales numbers from brick-and-mortar (non-Internet) distributors. Of course, the data is organized by entity metadata to correspond to the entities sold. These types of click data are described in greater detail with reference to FIG. 4.

Organized data elements 321, 322, 323, 329 are input to mapping operator 340 within the mapping process 104 performed by the system. Each element of organized data is mapped to the phase of consumption cycle 200 (see FIG. 2). The organized data 321, 322, 323, 329 thus contribute to the formation of the entity interest profile 210 (FIG. 2) with respect to the entity of interest. In an embodiment, the consumption cycle is merely a default consumption cycle; although a customized consumption cycle may be alternatively defined in the system, as described below.

The mapping of the organized data may be governed by both customer data 306 and by contextual data 308 in an embodiment. Customer data 306 and contextual data 308 may supplement any default mapping assignments in a mapping operator 340. The particular content of the customer data 306, or the semantic content of the contextual data 308, may determine, for example, whether a customer's viewing of a entity simulation should be considered part of the consideration phase or the trial phase of the consumption cycle 200 (FIG. 2).

In an embodiment, an analyst 364 (described below) may employ customer data 306 and contextual data 308 to design customized consumption cycles. For example, the analyst may want to design a customized consumption cycle that is a subset or superset of a default consumption cycle (FIG. 2). In particular to the example, the analyst may further segment the Awareness cycle into time-oriented phases to monitor customer activity after each phase of an advertising campaign that is launched prior to or during a TV program. In another example, the analyst may want to create a more complex creative organization of data types, grouped according to the analyst's own choices and preferences.

In any event, the data that has been mapped to the particular phases of the consumption cycle is used by calculation process 106. Calculation process 106 involves sub-process 362 which causes information to be displayed by sub-process 366 to an analyst 364, whereby the analyst 364 may provide customization inputs to sub-process 362. Thus, calculation process 106 may involve interaction with an analyst to calculate a “base power score” and a “final power scores.” The base and final power scores may each be referred to as a “power score.”

Briefly, the “base power score” may be determined by selectively weighting items of data of types 302, 304, 306, 308. The “final power score” may be determined by adjusting the base power score by multiplying by a series of factors or adding a series of terms. Finally, sub-process 366 uses the final power score to essentially determine the consumption forecast for the entity of interest. The weighting items would be preferably set based on the importance of factors in forecasting for the particular entity.

Referring more specifically to FIG. 3, the values corresponding to phases of the consumption cycle 200 are displayed for the analyst 364 via sub-process 366 as well as being input to the calculation sub-process 362. The calculation of base and final power scores is preferably determined in accordance with the customer data 306 and contextual data 308, although additional and/or other data may be used. In an embodiment, customer data 306 and contextual data 308 may be loosely considered to operate as “control inputs” to sub-process 362, whereas the mapped data from mapping process 104 and the entity interest profile values conform more closely to the concept of “data” that is processed. In any event, relevant data, including but not limited to, customer data 306, contextual data 308, raw click data 302 and metadata 304, may be displayed by sub-process 366. Accordingly, analyst 364 can use any or all the relevant data to customize the way in which sub-process 362 calculates the base and final power scores.

For example, in viewing displayed sales data (preferably from click data) overlaid with review data (preferably contextual data) provided by the system, the system may identify or provide a potential relationship or pattern in which sales appear to increase after a review by a certain publication type, regardless of the rating of the review. Based on this perception, the system can be programmed to increase the weighting of the review factual data and decrease the weighting of the rating data to more intelligently calculate power scores and forecast future consumption in blocks 362 and 368, respectively.

With the foregoing understanding of the data flow diagram of FIG. 3 as a background, reference is now made to FIGS. 4, 5, and 6 which illustrate examples of embodiments of respective steps/processes 102, 104, and 106.

FIG. 4 shows, in no particular order, various examples of activity information that may be gathered while monitoring the actions of customers. In Step 402, the system preferably gathers activity information on the number of customers (preferably, the number of unique customers) accessing entity-specific information over a given time period at a direct web site, a search engine, and/or a partner web site. In Step 404, the system preferably gathers the amount of entity information (news, previews, reviews, images, specifications, features, comments, webcasts, podcasts, talkbacks and discussions, comment board content, blog entries, advertisements, and the like) which are accessed by the customers.

In Step 406, the system preferably gathers a number of successful keyword searches performed by the customers on the principle that a click to information about a specific entity was the result of the keyword search. In an embodiment, the system gathers customer activity in which one or more customers typed in keyword searches immediately after consuming an entity to determine whether a particular customer interest relationship exists between the entity consumed and the entity searched thereafter. For example, the system may monitor and gather that a user types a keyword search for the music group “R.E.M.” after streaming or downloading an episode of the television program “Sesame Street” in which a skit on the shown included a song by R.E.M. Such customer activity may indicate strong relationship customer interest profile information between customers watching a particular show or episode and then purchasing a song, album or otherwise expressing interest in a musical artist on that show. It should be noted that the above television program and music group are only an example and that the system is capable of identifying relationships between two or more entities among one category or between two or more categories (e.g. books, videos, articles, television programs, movies).

Continuing on with FIG. 4, in Step 408, the system preferably gathers the number of individuals requesting ongoing informational updates or participating in a viral marketing campaign regarding the entity (also known “tracking”).

In Step 410, the system preferably gathers the number of media download requests for trailers, demos and the like by one or more customers for one or more entities. In Step 412, the system preferably gathers the number of video (e.g. trailers, commercials, actual programs), audio and/or gameplay streams initiated by the customers. It is contemplated that the system monitors whether the entire content file was streamed to indicate that the consumer was engaged in viewing or listening the program or whether only a portion the content was received (to indicate that the consumer lost interest or otherwise was not satisfied with the content). It is also contemplated that the system monitors whether customers repeatedly consumed the content by revisiting the stream multiple times.

In Step 414, the system preferably gathers the number of requests for pricing information or pre-orders of the entity by the customers prior to the launch of the entity. In Step 416, the system preferably gathers the number of message board or comments which are posted and/or viewed by the customers. In Step 418, the system preferably gathers the number of frequently asked questions (FAQs), hints, help files, guides and the like requested by the customers for a particular entity. In an embodiment, the system may be able to monitor whether customers are visiting online encyclopedias or other information specific sites prior to, during, or after consuming the entity. In particular, the system can monitor whether the customer visited Wikipedia or www.allmusicguide.com to find out more information about an actor or music band before, during, and/or after watching a program and/or listening to a song.

In Step 420, the system preferably gathers other specific entity activity information which is not discussed above. In an embodiment, the system may monitor and gather user activity among two or more entities which are not in the same product category, whereby the monitoring information may be used to develop a relational customer interest profile between the entities that would uncover and allow exploitation of potential opportunities in marketing, advertising and the like between those entities. In an example, the system may monitor click data that indicate that several thousand customers successively view a particular television program and then a website which only features Blu-Ray™ movies. Based on this simple example, the data may indicate that there is customer interest or demand for that particular television program (or series) in Blu-Ray™ format. This information may be provided to the television studio in which the studio may prioritize that television series to be available in Blu-Ray™ format.

Although the steps in FIG. 4 are illustrated sequentially, the steps may be performed concurrently or simultaneously, depending at least on the chosen system hardware implementation. Also, certain illustrated steps may be omitted altogether in a given implementation; conversely, steps may be included in an implementation even though they are not specifically illustrated in FIG. 4.

The illustrated information gathering steps focus on web site monitoring, in part because gathering “click data” can be automated more readily than other types of information gathering. However, customer activity information may be gathered from other sources. For example, sales data gathered from Internet web sites as well as brick-and-mortar (non-Internet) distributors can be gathered by the system.

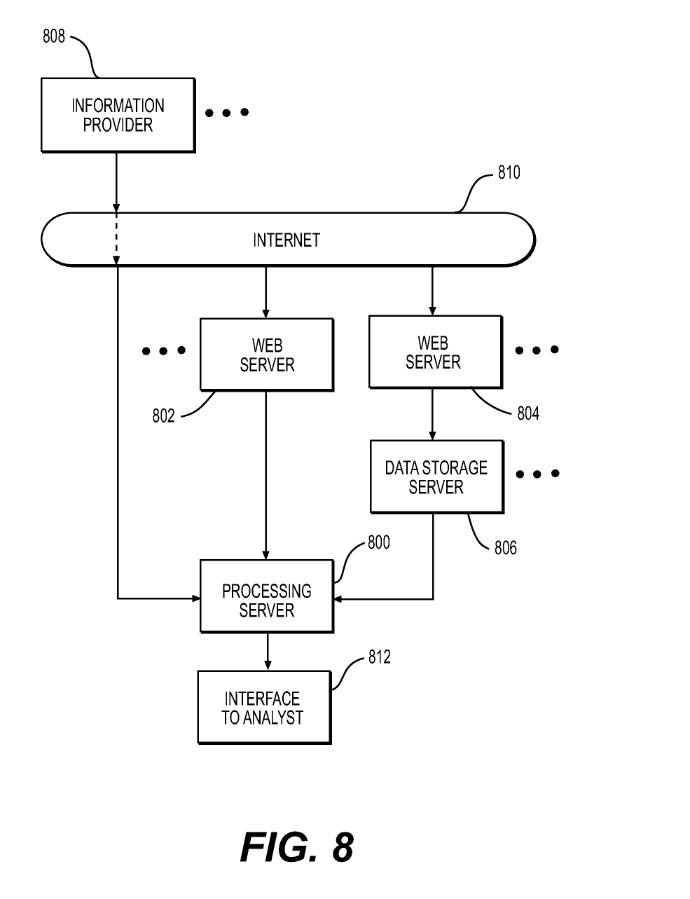

FIG. 5 shows, in no particular order, various steps of mapping examples of activity information to phases of a consumption cycle 200 (see FIG. 2). In Step 502 of the mapping activity process, the system preferably maps gathered activity information to a particular entity such that data continues to be associated with that entity during the rest of the analysis. In an embodiment, this mapping is carried out in a processing server 800 (see FIG. 8). This mapping contrasts with the initial data organization carried out by a web server in process 320 (FIG. 3) within the data gathering process 102. Third party data, such as historical sales or purchase data, may also be mapped to the entity and relevant customer interest level or phase.

In Step 504, the system preferably maps the number of customers accessing entity-specific information, including but not limited to the number of web sites, articles, advertisers, blogs and other information outlets which are discussing, promoting or otherwise covering the entity, to Phase 1 (Awareness phase) of the consumption cycle. In Step 506, the system preferably maps the number of requests for information on the system, the number of keyword searches of the entity and/or other information, to Phase 2 (Consideration phase) of the consumption cycle. In Step 508, the system preferably maps the gathered information on the number of downloads or streams of the entity, including but not limited to, demos, trailers, media samples, trial versions, and the like to Phase 3 (Trial phase) of the consumption cycle. In Step 510, the system preferably maps information on the number of preliminary orders, purchase requests, actual purchases or rentals and other information, to Phase 4 (Purchase phase) of the consumption cycle. In Step 512, the system preferably maps gathered information on reviewer and reader comments, scores (ratings), recommendations, number of posts, reviews and critiques, number of accesses of frequently asked questions (FAQs) and/or other appropriate information to Phase 5 (Engagement phase) of the consumption cycle.

Of course, FIG. 5's activity information types and consumption cycle phases are merely examples. Typically, many more types of activity information are mapped to consumption cycle phases than the two types per phase that are shown in FIG. 5. Generally, the mappings are many-to-one mappings, in that various types of customer activities correspond to a single phase or multiple phases of the consumption cycle. However, it is conceivable that some mappings may be one-to-one mappings. It is also conceivable that no activities may be mapped to a particular phase, in which case any level-of-interest measurement that might otherwise be associated with that phase would not contribute to the ultimate forecast of entity consumption.

Although the mapping steps in FIG. 5 are illustrated sequentially, the mapping steps may be performed concurrently or simultaneously, depending at least on the system hardware configuration. Also, certain illustrated mapping steps may be omitted altogether in a given implementation; conversely, steps may be included in an implementation even though they are not specifically illustrated in FIG. 5.

In an embodiment, the mapping in steps 504, 506, 508, 510, 512 is accomplished by merely storing data in destination storage locations that specifically correspond to a phase of the consumption cycle. In that embodiment, the data is not “tagged” as such. Accordingly, any process that reads the stored data knows the phase to which the data belongs, based simply on the data's storage location. Of course, alternative approaches to indicating the mapping, such as tagging the data by adding a “phase” field, can also be implemented.

FIG. 6 illustrates a flowchart of the processing of the entity interest profile to forecast future consumption of the entity in accordance with an embodiment. In FIG. 6, block 602 represents the optional step of displaying to an analyst any or all relevant information of the entity interest profile and/or any information that contributed to the formation of the entity interest profile. Displaying the contributing components permits the analyst to have a greater understanding of how the entity interest profile was formed. Other pertinent information may be presented in customizable displays which makes it easier for the analyst to understand how customer actions are affecting the entity interest profile and to decide how to favor (more heavily weight) various components or phase scores. The other pertinent information that is displayed may include, but is not limited to, click data 302, metadata 304, customer data 306, and contextual data 308 (FIG. 3).

If optional display step 602 is omitted in a particular implementation, control preferably proceeds directly to step 606. However, if display step 602 is included in a particular implementation, control passes to block 604 which represents a step in which the system allows the analyst to input customization choices based the analyst's own review and analysis of the information displays.

The analyst's customization choices may be used to determine how the customer interest profile in the one or more entities is processed to forecast consumption. For example, the analyst may specify a time period over which the customer activity is to be measured (for example, the last thirty days, last sixty days, yesterday) and/or a specific date or dates in the future to which the consumption forecast may apply. In this manner, the analyst may have the system forecast consumption three, six, nine, and twelve months in the future. The customization choices may include an entity and/or product category (e.g. comedies for television programs; heavy metal for music), which may be customized using fields from metadata 304 or contextual data sets 308. The customization choice may include having the system provide customer activity information from one or more consumption phases (for example, choosing to show results only from trial phase, or from trial and purchase phases, or for all phases). The customization choice may include having the system provide information on specific types of customer activity within a consumption phase (e.g. display only information requests and keyword searches, but not tracker data, in the trial phase).

Block 606 represents a step of forming scores for respective phases of the entity interest profile, in which scores may be based on collected activity data particular to those respective phases. It is preferred that scores for a phase are based on plural data, reflecting that the mapping of information to phases is generally many items-to-one phase mapping. However, it is conceivable that some phase scores may be based on a one or more pieces of information or type of information, reflecting that some mappings may be one-to-one mappings. It is also conceivable that some phases in some consumption cycles may have no scores, reflecting the situation in which no activities are mapped to that particular phase. The phase scores constituting the entity interest profile may be included with the other data (click data 302, metadata 304, customer data 306, and contextual data 308) in subsequent calculation steps.

Block 608 represents an optional step of exporting selected data from one computer system to another. The receiving computer may be a desktop, laptop, smartphone, cell phone or other electronic device. In an embodiment, the selected data may be exported to a server in which the information is reviewable by another party through a web site or extranet. If the exporting step is included, then subsequent processing can take place at a remote location, perhaps at a different company. Exporting thus allows one company to develop a comprehensive database, and sell all or selected parts of the database to client companies who may use the exported data for their own analysis. In this event, the client company is placed in the position of analyst 364 (FIG. 3).

It should be noted that the term “analyst” has been used in the context of a computer professional, but it is conceivable that an analyst may be an advertiser, studio, producer, distributor, consumer, website developer or any other individual. Data may be exported in formats suitable for the destination computer system's calculation processes, such as tab- or comma-delimited formats. The data exporting step can take place at other points in the flowchart of FIG. 6, for example after step 610, step 612 or step 618.

Block 610 represents a step of displaying data, to permit customized query and customization by the analyst. The display may include individual graphs, tables, or text, or combinations thereof. Events such as editorial coverage, advertising campaigns, marketing events, launch dates, and so forth, may be graphically overlaid on the customer activity data. This graphical overlay allows the analyst to perceive correlations between these events and customer activity that may result from the events.

More generally, data from multiple sources may be assembled into a single composite view that summarizes the state of customer interest in one or more entities within the same media class or among different media classes. This information may be presented in multiple ways, including: automated graphical reports; raw text; charts and graphs; and/or analyst-customized exports of particular data sets.

The system allows data to be displayed for any entity in which the data represents customer activity over a desired period of time. In an embodiment, the system displays data of customer activity for multiple entities which can then be compared to gauge relative levels of interest between the entities. Multiple entities may be selectively grouped by the system, whereby the entity group data may be compared to other entities or groups of entities. The system preferably allows the entity groups to be created by selecting one or more related or unrelated attributes among the entities.

In an embodiment, the system can be configured to display the top viewed entities for one or more selectable parameter filters. For example, it may be desired that the system display the ten most viewed television program sites on a particular website (e.g. tv.com) in the category of comedies. In the example, it is contemplated that the list of program sites be further analyzed by filtering the ten most viewed television comedy program sites based on viewed demographics (e.g. age, race, geographic area).

In an embodiment, the system may be configured to display vendors and/or advertisers most often mentioned in viewed content, whereby the vendor/advertiser content may be in the form of a commercial played when a program is viewed, a click-ad, banner-ad, and the like. In an embodiment, the system may take into account actual mentioning of the vendor/advertiser in a webpage, such as from a blog, a user comment, an article and the like.

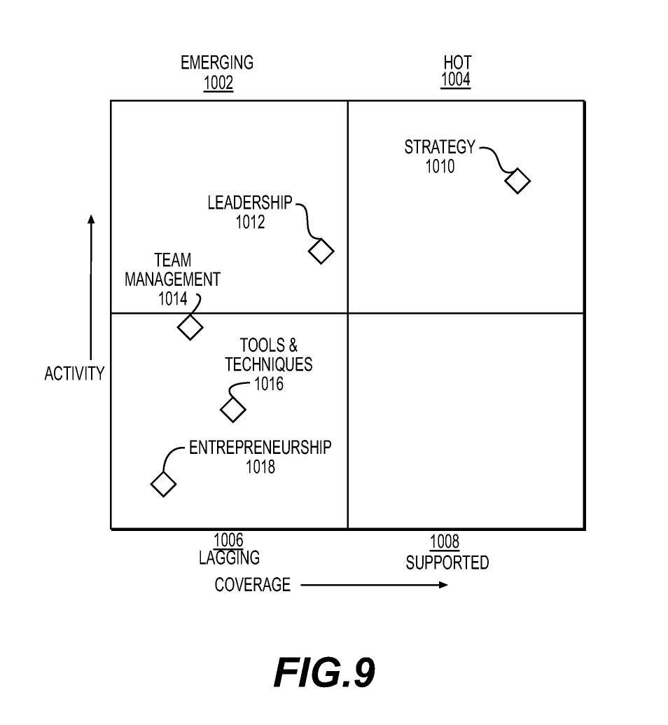

The system may be configured to display user activity information for particular entities in the form of a user activity barometer chart, as shown in FIG. 9. The user activity barometer chart shown in FIG. 9 includes four squares in which each square is selectively assignable by the analyst a particular characterization of interest. In particular, the barometer chart is characterized based on several article-based business-related topics of interest to users, whereby the amount of coverage (e.g. number of available articles, blogs, digital media content) is shown along the x-axis and the amount of customer activity on the topics along the y-axis. Regarding the individual squares, square 1002 is designated as an “emerging” topic, square 1004 is designated as a “hot” topic, square 1006 is designated as a “lagging” topic, and square 1008 is designated as a “supported” topic. In the example chart in FIG. 9, the system displays the processed customer activity data as a number of topic points, namely Strategy 1010, Leadership 1012, Team Management 1014, Tools and Techniques 1016 and Entrepreneurship 1018. The system displays in the chart in FIG. 9 that certain topics very popular (i.e. Strategy 1010) or emerging in popularity (i.e. Leadership 1012), whereas some other topics are not so popular in customer activity and media coverage (i.e. Team Management 1014, Tools and Techniques 1016 and Entrepreneurship 1018). It should be noted that the displayed chart may be used to gauge customer activity for any type of entity or among several types of entities and is thus not limited to those shown in FIG. 9.

Block 612 represents a step of inputting the analyst's further customization choices. These customization choices may differ from those entered in step 604 in that they benefit from the additional or refined knowledge made possible by the processing that has occurred in steps subsequent to step 604. For example, an example of such additional knowledge would be gained from the processing required for forming the phase scores in step 606.

As explained with reference to FIG. 3, the display of information in process 366 and the input of customization choices to process 362 is preferably an interaction that may be continued indefinitely. Block 614 represents a step of calculating a “base power score” that may be based in part on a combination of the scores from the entity interest profile from respective phases in the consumption cycle (FIG. 2). It is preferred that this calculation involve a sum of weighted scores from respective entity interest profile phases. The base power score is preferably based on combinations (for example, sums) of this and other weighted data. Other weighted data may, but not necessarily include click data 302, metadata 304, customer data 306, and/or contextual data 308.

The base power score may be a result of a simple linear combination of the entity interest profile's values and other data, with the weightings determined automatically by default settings or customized by analyst input. In an embodiment, each entity (e.g. an action computer game; prime time television program) in one or more corresponding product categories (e.g. other action-based computer games; other television programs aired at the same prime time slot) may be ranked in each relevant phase of the entity interest profile and in each data type.

Rankings may be determined by assigning an integer to an entity with a lower number indicating it to be more popular than other entities in the competitive set. A ranking of “1” would indicate the entity constitutes the most popular in the competitive set. A ranking of “2” would indicate the entity constitutes the second most popular entity in the competitive set, and so forth. Alternatively, an entity having a higher ranking number is considered more popular than an entity having a lower ranking number. In an embodiment, the rankings are combined by the system into a suitable combination scheme, such as an arithmetic sum of weighted rankings, to create the base power score for the entity. It should be noted that other known algorithms may be used to create the base power score other than that described above, and thus the system is not limited to the described algorithm.

Block 616 represents a step of the system creating the final power score by preferably using algorithms to adjust the base power score to account for additional factors deemed to be relevant. An additional factor may include the identity of any media base which supplies the entity for consumption by the customer. For example, the media base may be a web site (e.g. tv.com; last.fm.com) which hosts the programs which are broadcast or a gaming platform upon which a game is played (e.g. PlayStation 3™) in the market. Another factor which may be considered is previous history of the category to which the entity belongs. For example, sports games sell better than shooter games or reality shows are generally more popular than sitcoms. Another factor to be considered may be previous history of a franchise to which the entity belongs. For example, a franchise such as Nintendo's Mario™ franchise might be found to typically sell better than other game franchises; or television program series “Survivor” tends to have more viewers than “Hell's Kitchen”. Another factor that may be considered is the “Halo Effect” of an entity which is based on another licensed entity, such as a game that is based on a movie, celebrity, or television show (or vice versa), whereby the “Halo Effect” have been found to sell well. Other factors that may be considered are the impact of contextual data points (for example, data relating to advertising, viral marketing, public relations campaigns, distribution) and information of the Competitive set (e.g. games or programs that are competitive in terms of category, release date, or customer interest tend to have similar sales potential).

Adjusting the base power score may involve adding terms and/or applying multipliers to the base power score. The multipliers and/or terms may be provided by the analyst in which certain factors are considered more important than other factors. The base power score, summed with its added terms and/or multiplied by all its multipliers, forms the final power score.

Step 618 represents a step of the system providing a forecast of future consumption by one or more customers of the entity or entities in which the forecast is preferably based on the final power score from step 616. Whereas the power scores may be unit-less abstract values, the consumption forecast is preferably expressed in units appropriate to the entity, category to which the entity belongs, or other entity being studied. For example, a consumption forecast may constitute a specific number of units of a computer game sold during a given month in the future or the number of views of a particular program on a web site or through a TV broadcast.

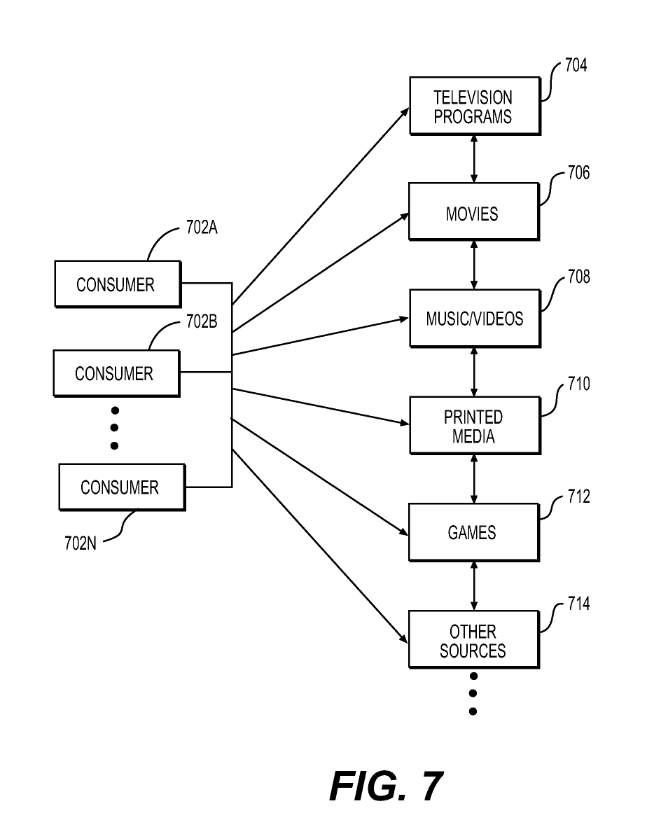

FIG. 7 illustrates a block diagram of the system monitoring customer activity among one or more Internet websites in determining forecast in accordance with an embodiment. As shown in FIG. 7, one or more customers 702 access one or more Internet websites over a given period in which customer activity data among those websites is monitored and stored. The stored information is then utilized by the present system in analyzing and forecasting future consumption as described above. In FIG. 7, the several discrete Internet websites are shown, whereby each Internet website is directed to sharing (e.g. free content), selling, renting or otherwise providing information (e.g. You Tube, CNET, ZDNet) about a particular type of a consumer entity. The discreet websites shown in FIG. 7 are a television/cable program website 704 (e.g. www.cbs.com, www.hulu.com); a movie provider website 706 (e.g. Netflix, Amazon); a music provider website 708 (e.g. iTunes; last.fm; Rhapsody); a printed media website (e.g. www.wallstreetjournal.com; www.zdnet.com); and a video game website (gamefly.com; gamespot.com). It should be noted that the websites shown and described in FIG. 7 are distinct from one another in the types of content they provide to the customers for example purposes only. Thus, it is contemplated that one or more of the websites may provide more than one type of content (e.g. television programs and movies; printed media and music/videos). It is also contemplated that additional/alternative websites providing media and/or content not already described may be monitored for customer activity in accordance with an embodiment. It is also possible that the system receive customer activity information from sources other than media content providing Internet websites, such as Facebook™, My Space™ and Twitter™. Customer activity information may also be received from web-based and non web-based sources 714 including but not limited to, Playstation™ Store; Xbox Live™; iTunes™; Rhapsody™ Netflix™; Tivo™ and other digital video recorders, cable and satellite services; digital- and/or subscription-based radio stations; HD Radio and the like.

In the embodiment in FIG. 7, one or more of the websites or other sources communicate with processing and/or storage servers or memories, described in more detail below. One or more users or customers 702A, 702B, . . . 702N (referred generally as 702) access these websites or other sources which may be dedicated to one or more particular product categories (e.g. CBSi for video content, last.fm for music and the like), whereby the users' navigation activity and interaction within the various sites or sources provide meaningful data which may be used in developing relational customer interest profiles and forecasting consumption of one or more entities.

In an example, one or more customers 702 may visit the television program website 704 and type search terms for a particular television show and/or navigate among the website. The system monitors these activities on the website and stores the information to one or more servers to gather and store this customer activity information. It is also contemplated that the system may monitor these activities among several different sources in gathering customer activity information. The customer activities in a particular website may include but are not limited to, search terms input by the customer; links or advertisements selected by the customer; comments made by the customer or particular entities recommended to others; entities viewed, listened or otherwise consumed on the website; purchase or rental of the entity by the customers and the like.

In an example, the system may monitor activities of several thousand customers who visit a television program site to watch a particular television show (“show 1”). In the example, the system would monitor and store information regarding user activity before, during and/or after the users consumed show 1 to determine whether some of the users searched, navigated toward, consumed or otherwise engaged in activity which showed interest in another particular upcoming television program (“show 2”). This monitored customer activity may uncover a particular affinity toward show 2 based on customers who typically viewed show 1. This relational information may be used to establish a relational customer interest profile which may have a high score that indicates that future forecast that consumption of show 2 will be high (or dismal) based on the success of show 1. This information may be provided to advertisers and/or production companies who may benefit in advertising during the broadcast of show 1 and/or advertising their products during the airing of show 2.

It is also possible that information can be gathered among multiple websites which offer entities in different product categories (as represented by the arrows among sites 704-712 in FIG. 7). For example, the system may monitor online activity of several thousand customers who visit a television program site to watch a broadcasted concert and a music provider site within a certain number of clicks from one another prior to a broadcast of an upcoming television concert. The system may continue to monitor the sites to determine any increase in user activity at the music site after the concert has been broadcasted. The system may use the gathered information to not only forecast that there is significant interest in the upcoming broadcast, but that the broadcast led to an increase in the number of downloads, sales or other consumption of the artist's music catalog. This information may be helpful to the producer of the broadcasted concert to determine whether other concerts (by the same or different artist) should be produced and broadcast and/or whether to make available music tracks by that artist.

With regard to customer activity on the Internet, the system can thus monitor customer activities to measure potential and actual interests and forecast media consumption before or during a particular phase cycle. Monitoring user activity on websites which provide interactive media provides opportunities to develop customer interest profiles from users who not only consume the media entity, but also who interact with others (as part of a community of interest associated with specific content) or provide direct feedback on their interests associated with the specific content of the entity. The system's ability to derive useful information based on a user's consumption and interaction with media and provide this information, along with analysis, to interested parties is significantly advantageous.

Referring now to FIG. 8, a system on which the foregoing methods may be implemented is provided. Connected to the Internet 810 (or other suitable network from which information is gathered) are one or more web servers shown schematically as elements 802, 804. Web servers 802, 804 gather information from information sources such as web sites on Internet 810, thus performing step 102 (FIGS. 1, 3, 4). Information from other sources, schematically indicated as information provider 808, may also be gathered.

Web server 802 preferably gathers information and sends it directly to a processing server 800. In an alternative arrangement, web server 804 sends data to a data storage server 806 before the data is forwarded to the processing server 800. In still another arrangement, information provider 808 provides information directly to the processing server 800 via a suitable communications path, such as Internet 810. Processing server 800 preferably receives data gathered by sources 802, 804/806, 808, and other sources not shown, and carries out a mapping step 104 (FIGS. 1, 3, 5) and calculation step (FIGS. 1, 3, 6). Analyst 364 (FIG. 3) preferably interacts with the processing server 800 by a suitable interface 812 via a client computer.

As one example of the system, one implementation of the various servers in FIG. 8 is described. Element 802 may be implemented as plural web servers that perform different respective functions. In one approach, a first web server collects various data types (click data 302, metadata 304, customer data 306, and contextual data 308) and automatically synchronizes data with processing server 800. In the approach, a second web server preferably collects only click data with the processing server reading the data on a scheduled basis.

Web server 804 may be of any appropriate type in the market, the data gathering code being preferably implemented in PHP or other general purpose scripting language. Data in the form of text files is preferably sent on a scheduled basis to data storage server 806. Data storage server 806 may be any appropriate type of machine. Data storage server preferably does not perform any of the functions 102, 104, 106 (FIG. 1) but serves as an intermediate storage location for data from web server 804.

Information provider 808 may be a brick-and-mortar (non-Internet) distributor providing entity sales numbers by automated or manual data entry. Processing server 800 preferably performs the mapping and calculation steps/processes 104, 106 (FIGS. 1, 3). Processing server may be any appropriate machine and using a database (e.g. SQL) server, the mapping and calculation code being written in appropriate web tool and scripting languages. Interface 812 may be conventional in design, and may include a monitor, speakers, keyboard, mouse, and the like.

The servers described herein may be distributed differently than as presented in FIG. 8 in given applications, for considerations such as performance, reliability, cost, and so forth. More generally, the various computers shown in FIG. 8 may be implemented as any appropriate server employing technology known by those skilled in the art to be appropriate to the functions performed. A server may be implemented using a conventional general purpose computer programmed according to the foregoing teachings, as will be apparent to those skilled in the computer art. Appropriate software can readily be prepared by programmers of ordinary skill based on the teachings of the present disclosure, as will be apparent to those skilled in the software art. Other suitable programming languages operating with other available operating systems may be chosen.

General purpose computers may implement the foregoing methods, in which the computer housing may house a CPU (central processing unit), memory such as DRAM (dynamic random access memory), ROM (read only memory), EPROM (erasable programmable read only memory), EEPROM (electrically erasable programmable read only memory), SRAM (static random access memory), SDRAM (synchronous dynamic random access memory), and Flash RAM (random access memory), and other special purpose logic devices such as ASICs (application specific integrated circuits) or configurable logic devices such GAL (generic array logic) and reprogrammable FPGAs (field programmable gate arrays).

Each computer may also include plural input devices (for example, keyboard, microphone, and mouse), and a display controller for controlling a monitor which displays the results and forecast data to the analyst. Additionally, the computer may include a floppy disk drive; flash or solid state memory device, other removable media devices (for example, compact disc, tape, and removable-magneto optical media); and a hard disk or other fixed high-density media drives, connected using an appropriate device bus such as a SCSI (small computer system interface) bus, an Enhanced IDE (integrated drive electronics) bus, or an Ultra DMA (direct memory access) bus. The computer may also include a compact disc reader, a compact disc reader/writer unit, or a compact disc jukebox, which may be connected to the same device bus or to another device bus.

Such computer readable media further include a computer program or software including computer executable code or computer executable instructions that, when executed, causes a computer to perform the methods disclosed above. The computer code may be any interpreted or executable code, including but not limited to scripts, interpreters, dynamic link libraries, Java classes, complete executable programs, and the like.

The foregoing embodiments are merely examples and are not to be construed as limiting the invention. The description of the embodiments is intended to be illustrative, and not to limit the scope of the claims. Many alternatives, modifications, and variations will be apparent to those skilled in the art in light of the above teachings. For example, the choice of different hardware arrangements, software implementations, instruction execution schemes, data types, data structures, and so forth, lie within the scope of the present invention. It is therefore to be understood that within the scope of the appended claims and their equivalents, the invention may be practiced otherwise than as specifically described herein.

What is claimed is:

1. A method comprising:
monitoring online user activity of one or more customers with regard to a first consumer entity, wherein the user activity represents the one or more customer's interest in the first consumer entity, the first consumer entity being categorized in a first product category;
monitoring the online user activity of the one more customers with regard to a second consumer entity categorized in a second product category different than the first category;
recording the monitored activity information to one or more memory or data storage devices associated with a computer;
mapping the monitored activity information to a relational customer interest profile that represents a level of the one or more customer's interest at one or more corresponding phases of a consumption cycle with respect to the first and second consumer entities, wherein the mapping is performed by a processor; and
processing at least the mapped activity information to formulate a forecast of future consumption of at least the first consumer entity, wherein the processing is performed by the processor or another processor.

2. The method of claim 1, wherein the activity information of the first consumer entity includes consumption of the first consumer entity.

3. The method of claim 1, wherein the mapped activity information formulates a forecast of future consumption of at least the second entity.

4. The method of claim 1, wherein the first consumer entity is a television program, wherein the television program is viewable via a video player on an Internet web site.

5. The method of claim 1, wherein the first consumer entity is an audio file.

6. The method of claim 1, wherein the monitoring customer activity information further comprises monitoring customer activity on a first Internet web site displaying information the first consumer entity and a second Internet web site displaying information of the second consumer entity.

7. The method of claim 1, wherein the monitoring customer activity information further comprises monitoring customer activity between more than one Internet web site.

8. The method of claim 1, wherein the monitoring customer activity further comprises monitoring a media file which is consumed by the customer via an Internet web site.

9. The method of claim 1, wherein the monitoring activity information further comprises monitoring a keyword search performed by a user on an Internet web site.

10. The method of claim 1, wherein the processing further comprises;
weighting scores of information contributing to the customer interest profile in corresponding phases of the consumption cycle;
combining the weighted scores so as to form a power score; and
determining the forecast of future consumption of the first consumer entity based on the power score.

11. The method of claim 1, wherein the activity information further comprises at least one of click data representing customer activity between a plurality of Internet web sites; metadata representing entity attributes; customer data representing attributes of at least one customer's respective activities; and contextual data representing contexts of entities.

12. A system comprising:
means for monitoring online user activity of one or more customers with regard to a first consumer entity, wherein the user activity represents the one or more customer's interest in the first consumer entity, the consumer entity being categorized in a first product category;
means for monitoring the online user activity of the one more customers with regard to a second consumer entity categorized in a second product category different than the first category;
means for recording the monitored activity information to one or more memory or data storage devices associated with a computer;
means for mapping the monitored activity information to a relational customer interest profile that represents a level of the one or more customer's interest at one or more corresponding phases of a consumption cycle with respect to the first and second consumer entities, wherein the mapping is performed by a processor; and
means for processing at least the mapped activity information to formulate a forecast of future consumption of at least the first consumer entity, wherein the processing is performed by the processor or another processor.

13. The system of claim 12, wherein the activity information of the first consumer entity includes consumption of the first consumer entity.

14. The system of claim 12, wherein the mapped activity information formulates a forecast of future consumption of at least the second entity.

15. The system of claim 12, wherein the first consumer entity is a television program, wherein the television program is viewable via a video player on an Internet web site.

16. The system of claim 12, wherein the first consumer entity is an audio file.

17. The system of claim 12, wherein the means for monitoring online user activity information monitors customer activity on a first Internet web site displaying information the first consumer entity and a second Internet web site displaying information of the second consumer entity.

18. The system of claim 12, further comprising means for monitoring customer activity among more than one Internet web site.

19. The system of claim 12, wherein the means for monitoring monitors consumption of a media file by one or more customers via an Internet web site.

20. The system of claim 12, wherein the means for monitoring monitors a keyword search performed by one or more users on an Internet web site.

21. The system of claim 12, wherein the activity information further comprises at least one of click data representing customer activity on an Internet web site; metadata representing entity attributes; customer data representing attributes of at least one customer's respective activities; and contextual data representing contexts of entities.
